(19) United States
(12) Patent Application Publication
(10) Pub. No.: US 2022/0180759 A1
(43) Pub. Date: Jun. 9, 2022

(54) ANTI-DRONE INTEGRATED MANAGEMENT DEVICE AND OPERATION METHOD THEREOF

(71) Applicant: Electronics and Telecommunications Research Institute, Daejeon (KR)

(72) Inventors: kyu-Min KANG, Daejeon (KR); Jae Cheol PARK, Daejeon (KR)

(73) Assignee: Electronics and Telecommunications Research Institute, Daejeon (KR)

(21) Appl. No.: 17/540,494

(22) Filed: Dec. 2, 2021

(30) Foreign Application Priority Data
Dec. 4, 2020 (KR) 10-2020-0168047
Apr. 14, 2021 (KR) 10-2021-0048176

(51) Int. Cl. G08G 5/00; G01S 13/72; B64C 39/02

(52) U.S. Cl. CPC G08G 5/0082; G08G 5/0039; B64C 2201/027; G01S 13/72; B64C 39/024; G08G 5/0013

(57) ABSTRACT

An anti-drone integrated management device includes a drone detection unit that detects at least one drone invading a restricted area, a drone ID identification unit that requests drone unique information to the at least one detected drone, and receives drone unique information from the at least one detected drone, a drone ID identification information storage/management unit that stores and updates the drone unique information received by the drone ID identification unit, an anti-drone integrated controller that determines whether to neutralize the at least one detected drone based on the drone unique information stored in the drone ID identification information storage/management unit, and a drone neutralization unit that neutralizes the at least one detected drone under control of the anti-drone integrated controller.

### CROSS-REFERENCE TO RELATED APPLICATIONS

This application claims priority under 35 U.S.C. § 119 to Korean Patent Application No. 10-2020-0168047 filed on Dec. 4, 2020 and Korean Patent Application No. 10-2021-0048176 filed on Apr. 14, 2021, in the Korean Intellectual Property Office, the disclosures of which are incorporated by reference herein in their entireties.

### BACKGROUND

Embodiments of the present disclosure described herein relate to an anti-drone system, and more particularly, relate to an anti-drone integrated management device for linking drone detection, ID identification, and neutralization technologies and an operation method thereof.

Recently, as the use of drones has spread, cases of dysfunction such as invasion of privacy or security threats to important facilities are increasing. An anti-drone device to which a drone detection technology and a neutralization technology to operate in a prohibited area or a restricted area are applied are used to respond to such cases of dysfunction of drones. In the early stages of response, an object invading the prohibited area is detected to determine whether the detected object is a drone. When needing to neutralize the drone, the intrusion or threat of the drone is removed using a physical method such as jamming, geofencing, net capture, or laser beams.

As such, an existing anti-drone device focuses on the detection and neutralization technologies and does not consider a drone identification technology of identifying and managing drone unique information (e.g., a drone ID, position information, or the like). However, small drones may be moved in the air and controlled remotely without specific expertise, so they may be easily used for safety and security threats and criminal activities such as invasion of privacy. Upon occurrence of an accident, it is difficult to track small drones and determine who is responsible. Thus, interest in drone ID identification is growing, and recently, major countries such as the United States, Europe, and China are promoting policy and technology development for drone identification. In December 2019, the U.S. Federal Aviation Administration (FAA) announced a public notice on legislation for remote identification of unmanned aerial vehicle systems, and the European Commission announced that registration and electronic identification would be mandatory for all drones from 2019. Thus, there is an urgent need for a technology capable of implementing neutralization through drone ID identification.

### SUMMARY

Recently, as the number of cases of dysfunction of drones such as aircraft take-off and landing suspension accidents due to the appearance of drones in airports and drone crashes in nuclear power plants increases, interest in developing an anti-drone integrated management solution that may effectively respond to illegal drones is increasing. An existing anti-drone system focuses on a drone detection technology using a ground radar, an RF scanner, an electrooptic-infrared (EO/IR) camera, or the like and a neutralization technology using a physical method, a jamming device, or the like. However, such a drone dysfunction response system lacks a drone identification technology, so there are limitations in responding to illegal drones such as follow-up measures such as identification of liability and insurance processing upon occurrence of a drone accident and unilateral suspension of operation without considering the purpose of drone operation. Thus, to supplement an existing 2-step drone dysfunction response system of ‘detection and neutralization’ into a 3-step response system of ‘detection, ID identification, and neutralization’, there is a need for additionally linking and forming a drone ID identification device capable of identifying drone unique information (e.g., a drone ID, a position information, or the like) in an anti-drone system and develop a system operation technology according to it.

Embodiments of the present disclosure provide an anti-drone integrated management technology for linking a drone detection device, a drone ID identification device for ground, a drone Identification information storage/management unit, a drone neutralization device, and an anti-drone integrated management device to track illegal and threat drones in real time and effectively integrate and manage the illegal and threat drones, when the plurality of drones appear in a prohibited area or a restricted area.

According to an embodiment, an anti-drone integrated management device may include a drone detection unit that detects at least one drone invading a restricted area, a drone ID identification unit that requests drone unique information to the at least one detected drone, and receives drone unique information from the at least one detected drone, a drone ID identification information storage/management unit that stores and updates the drone unique information received by the drone ID identification unit, an anti-drone integrated controller that determines whether to neutralize the at least one detected drone based on the drone unique information stored in the drone ID identification information storage/management unit, and a drone neutralization unit that neutralizes the at least one detected drone under control of the anti-drone integrated controller.

In an embodiment, the drone unique information may include ID information assigned to the at least one detected drone or position information.

In an embodiment, the drone ID identification unit may include at least one antenna. The anti-drone integrated controller may adjust an azimuthal angle and an elevation angle of the at least one antenna based on the position information.

In an embodiment, the drone ID identification unit may include at least one antenna. The drone ID identification unit may receive the position information and may adjust an azimuthal angle and an elevation angle of the at least one antenna without intervention of the anti-drone integrated controller.

In an embodiment, the anti-drone integrated controller may determine response priorities for a plurality of drones depending on a predetermined policy, when the plurality of drones are detected.

In an embodiment, the response priorities may be determined according to a distance from major key facilities in the restricted area among the plurality of drones or a distance from the anti-drone integrated management device.

In an embodiment, the anti-drone integrated controller may determine whether to neutralize the at least one detected drone by additionally using flight registration information, owner information, or flight approval information of the at least one detected drone other than the drone unique information.

In an embodiment, a wired link or a wireless link for transmitting a command, control, or data in real time may be configured between the drone ID identification unit and the drone ID identification information storage/management unit or between the anti-drone integrated controller and the drone ID identification unit, the drone ID identification information storage/management unit, the drone detection unit, or the drone neutralization unit.

In an embodiment, the at least one drone may include an identification device for drone mounting for providing the drone unique information to the drone ID identification unit.

In an embodiment, the drone detection unit, the drone ID identification unit, the drone ID identification information storage/management unit, the anti-drone integrated controller, and the drone neutralization unit may be spaced apart from each other above a specific distance to be scattered and arranged.

According to an embodiment, an operation method of an anti-drone integrated management device for monitoring a restricted area may include detecting at least one drone invading the restricted area, obtaining ID information and position information of the at least one detected drone, determining whether to neutralize the at least one detected drone based on the ID information, the position information, and additional information, and neutralizing the at least one detected drone depending on the determined result.

In an embodiment, the additional information may include body registration information, owner information, or flight approval information about the at least one detected drone.

In an embodiment, the operation method may further include determining response priorities for a plurality of drones, when the at least one detected drone is the plurality of drones.

In an embodiment, the anti-drone integrated management device may include a drone ID identification unit having an antenna for receiving the ID information and the position information provided from the at least one detected drone. The operation method may further include adjusting an azimuthal angle and an elevation angle of the antenna to receive the ID information and the position information.

### BRIEF DESCRIPTION OF THE FIGURES

The above and other objects and features of the present disclosure will become apparent by describing in detail embodiments thereof with reference to the accompanying drawings.

FIG. 1 is a drawing illustrating an anti-drone integrated management system according to an embodiment of the present disclosure;

FIG. 2 is a drawing illustrating a configuration of an anti-drone integrated management device according to an embodiment of the present disclosure;

FIG. 3 is a drawing illustrating a scheme where an anti-drone integrated management device according to an embodiment of the present disclosure operates when a plurality of drones appear; and

FIG. 4 is a flowchart illustrating an operation method of an anti-drone integrated management device according to an embodiment of the present disclosure.

### DETAILED DESCRIPTION

Below, embodiments of the present disclosure will be described in detail and clearly to such an extent that an ordinary one in the art easily implements the present disclosure.

It should be understood that both the foregoing general description and the following detailed description are provided as examples, and it should be regarded as an additional description is provided. Reference numerals will be represented in detail in embodiments of the present disclosure, examples of which are illustrated in the accompanying drawings. Wherever possible, the same reference numerals are used in the drawings and the description to refer to the same or similar parts. Hereinafter, embodiments of the present disclosure will be described with reference to accompanying drawings in order to describe the embodiments of the present disclosure in detail to the extent that one skilled in the art may be easily implement embodiments.

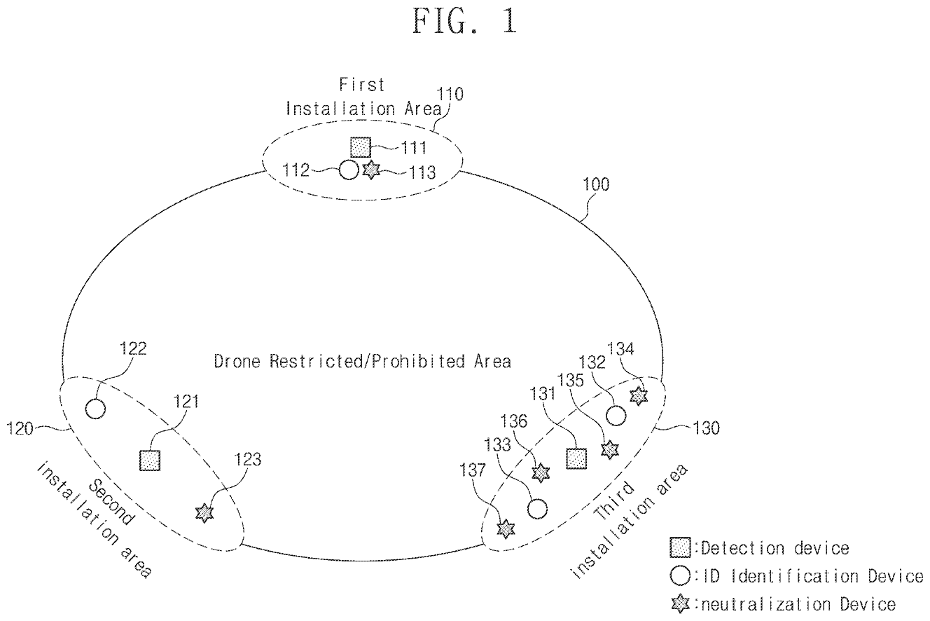

FIG. 1 is a drawing illustrating an anti-drone integrated management device according to an embodiment of the present disclosure. Referring to FIG. 1, a scheme where an anti-drone integrated management device or system is disposed in a drone restricted/prohibited area 100 set to protect national major facilities such as airports or nuclear power plants is illustrated.

The anti-drone integrated management device may include respective devices (a detection device, an ID identification device, and a neutralization device) which are arranged and operated in various forms according to an operation entity, an operation area, an operation purpose, or the like. For example, the anti-drone integrated management device may be disposed according to a scheme of at least one of installation or operation environments shown in each of installation areas 110, 120, and 130.

The first installation area 110 shows a scheme where a detection device 111, an ID identification device 112, and a neutralization device 113 are intensively arranged one by one in the same location to make up the anti-drone integrated management device.

The second installation area 120 shows a scheme where a detection device 121, an ID identification device 122, and a neutralization device 123 are arranged one by one to make up the anti-drone integrated management device. Herein, detection device 121, the ID identification device 122, and the neutralization device 123 are scattered, installed, and operated in different locations.

The third installation area 130 shows a scheme where a detection device 131, ID identification devices 132 and 133, and neutralization devices 134, 135, 136, and 137 are arranged in the form of being plural and scattered to make up the anti-drone integrated management device. Herein, the at least two ID identification devices 132 and 133 and the neutralization devices 134, 135, 136, and 137 are illustrated. Such an arrangement scheme may be changed according to a security level or importance of the drone restricted/prohibited area 100.

As described above, for convenience of description in an embodiment of the present disclosure, the anti-drone integrated management device is described assuming that the three arrangement scenarios are, for example, the first to third installation areas 110, 120, and 130. However, it may be well understood that the shown examples are only exemplary configurations for convenience of description. In other words, the detection device (e.g., a radar, a scanner, an electrooptic-infrared (EO/IR) camera, or the like), the ID identification device (e.g., a drone ID identification device for ground and a drone ID identification information storage/management unit; assuming that an identification device for drone mounting is mounted on the drone), the neutralization device (e.g., a jammer, a laser beam, or the like) may be installed and operated at various points according to a drone dysfunction response policy of the facility operator. In this case, control/command/data information between the devices (the detection device, the ID identification device, and the neutralization device) should be configured to be delivered to a wired link or a wireless link in real time.

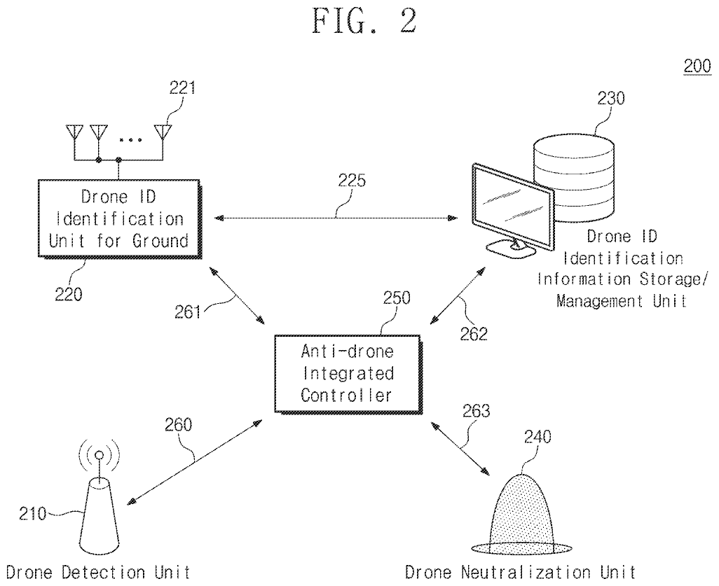

FIG. 2 is a drawing illustrating a configuration of an anti-drone integrated management device according to an embodiment of the present disclosure. Referring to FIG. 2, an anti-drone integrated management device 200 may include a drone detection unit 210, a drone ID identification unit 220 for ground, a drone ID identification information storage/management unit 230, a drone neutralization unit 240, and an anti-drone integrated controller 250. Each of these devices may be developed and manufactured to be configured independently in one form, and two or more of these devices may be developed and manufactured to be configured in the form of one system in hardware.

The drone detection unit 210 may be a device for detecting an object invading a prohibited area or a restricted area and determining whether the detected object is a drone in the early stage of response, using a radar, an RF scanner, an EO/IR camera, or the like.

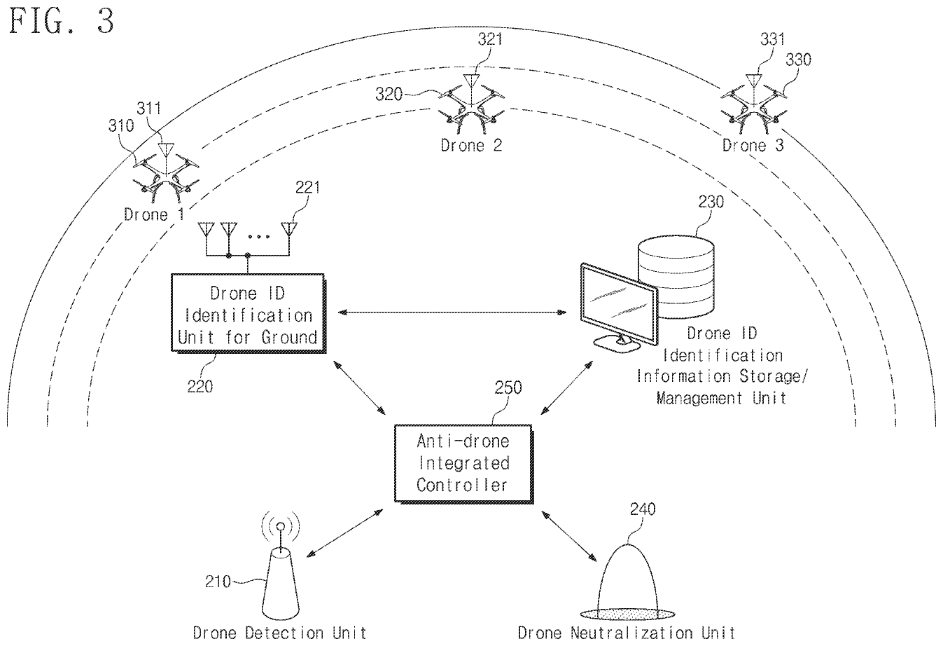

The drone ID identification unit 220 for ground may be a device for identifying an ID of the detected drone. The device for identifying the ID of the detected drone may further include an ID identification device for drone mounting (which will be described with reference to FIG. 3) other than the drone ID identification unit 220 for ground. The drone ID identification unit 220 for ground may include an antenna 221 for communication with the detected drone. The antenna 221 may be manufactured to be able to control an azimuthal angle and an elevation angle. The adjustment of the azimuthal angle and the elevation angle of the antenna 221 is able to be performed in the drone ID identification unit 220 for ground or by means of control linked with an adjacent device such as the anti-drone integrated controller 250 or the like. In an embodiment of the present disclosure, a description will be given of an example of a scheme where the azimuthal angle and the elevation angle of the antenna 221 are adjusted by control of the anti-drone integrated controller 250. In addition, it is expected that all drones of a reference condition or more (e.g., all drones needing registration, all drones, each of which has a body weight of 250 g or more, or the like) must mount an identification device for drone mounting when related system is established in the future. Thus, the ID identification device for drone mounting, which is mounted on the drone, and the drone ID identification unit 220 for ground, which is installed on the ground, may be used to transmit and receive drone unique information (e.g., a drone ID, position information, or the like) and manage the drone safely in an integrated manner.

The drone ID identification information storage/management unit 230 may store and manage pieces of ID information of drones which may or may not access the drone restricted/prohibited area 100. For example, the drone ID identification information storage/management unit 230 may store pieces of ID information of drones allowed (or approved) to fly on the drone restricted/prohibited area 100 and may identify whether it is matched in response to a request to check whether flight is approved from the drone ID identification unit 220 for ground. The drone ID identification information storage/management unit 230 may check whether it is an ID registered with the drone ID identification information storage/management unit 230 and may provide the result to the drone ID identification unit 220 for ground.

When the ID of the detected drone is an illegal drone which is not allowed, the drone neutralization unit 240 may remove the Intrusion or threat of the illegal drone by means of jamming, destruction, capture, geofencing, or the like. The drone neutralization unit 240 may disrupt communication of the illegal drone or GPS communication through, for example, jamming to crash the illegal drone or to force the illegal drone to land, force the illegal drone back, or the like. Alternatively, the drone neutralization unit 240 may aim and fire at the illegal drone with firepower such as a laser, a shotgun, or an electromagnetic pulse (EMP) to directly destroy the illegal drone. In addition, the drone neutralization unit 240 may neutralize the illegal drone using means of catching by firing nets or mobilizing various means.

The anti-drone integrated controller 250 may integrate and adjust the overall operations of the drone detection unit 210, the drone ID identification unit 220 for ground, the drone ID identification information storage/management unit 230, and the drone neutralization unit 240. The anti-drone integrated controller 250 may check presence of a drone which approaches or break into a surveillance area from the drone detection unit 210. When it is identified that the drone is broken into the surveillance area over a channel 260, the anti-drone integrated controller 250 may control such that an antenna 221 of the drone ID identification unit 220 for ground or the ID identification device for drone mounting checks an ID of an intrusion drone through a channel 261. Information indicating whether the drone ID checked by the drone ID identification unit 220 for ground or the ID identification device for drone mounting is illegal may be delivered over a channel 225 or 262 with the drone ID identification information storage/management unit 230. When it is determined that the ID of the invading drone is an illegal drone which is not allowed, the anti-drone integrated controller 250 may instruct the drone neutralization unit 240 to neutralize the drone over a channel 263.

Herein, the drone ID identification unit 220 for ground and the drone ID identification information storage/management unit 230 may be installed on the ground, and the ID identification device for drone mounting may be mounted on the drone to be operated. Furthermore, the drone ID identification unit 220 for ground and the drone ID identification information storage/management unit 230 may be separately developed and operated independently of each other or may be developed and operated in the form of one hardware. The channels 225, 260, 261, 262, and 263 for exchanging command/control/data information needed between the devices 210, 220, 230, 240, and 250 may make up a wired link or a wireless link which may communicate in real time.

FIG. 3 is a drawing illustrating a scheme where an anti-drone integrated management device according to an embodiment of the present disclosure operates when a plurality of drones appear. Referring to FIG. 3, it is assumed that three drones 310, 320, and 330 respectively mounting ID identification devices 311, 321, and 331 for drone mounting appear in a drone restricted/prohibited area.

First of all, a drone detection unit 210 may detect the three drones 310, 320, and 330 invading within a detection radius of the drone restricted/prohibited area. Next, the drone detection unit 210 may report positions where the drones 310, 320, and 330 are detected to an anti-drone integrated controller 250. The anti-drone integrated controller 250 may determine response priorities for the detected drones 310, 320, and 330 depending on a predetermined anti-drone response rule. The anti-drone response rule may be previously determined according to an operation environment, an operation purpose, or the like of an institution which operates an anti-drone integrated management system. For example the anti-drone response rule may be a policy which first responds from a drone close in distance from a point where the anti-drone integrated management system is installed. Alternatively, the anti-drone response rule may be determined to respond to a drone which is closest from major key facilities in a drone restricted/prohibited area.

When the response priorities are determined, the anti-drone integrated controller 250 may set and control an azimuthal angle and an elevation angle of an antenna 221 installed in a drone ID identification unit 220 for ground to better receive and identify drone unique information transmitted from the drone. It will be well understood that the drone detection unit 210 is able to implement a scheme of controlling an azimuthal angle and an elevation angle of an antenna of an ID identification device 311, 321, or 331 for drone mounting, which is directly mounted on the drone, according to a scheme of implementing the anti-drone integrated management system for enhancing the efficiency of receiving the unique information of the drone.

Next, the drone ID identification unit 220 for ground may collect drone unique information (e.g., a drone ID, position information, or the like) and may store the information in a drone ID identification information storage/management device 230. The drone ID identification information storage/management device 230 may additionally obtain body registration information, owner information, flight approval information, or the like of the drone using a drone ID by interworking with a database of government agencies (not shown). After identifying in detail an operation purpose of the drone invading a corresponding point or the like based on the drone unique information and the additionally obtained information, when it is determined that there is a need to neutralize the drone, the anti-drone integrated controller 250 may operate a drone neutralization unit 240 to neutralize the drone.

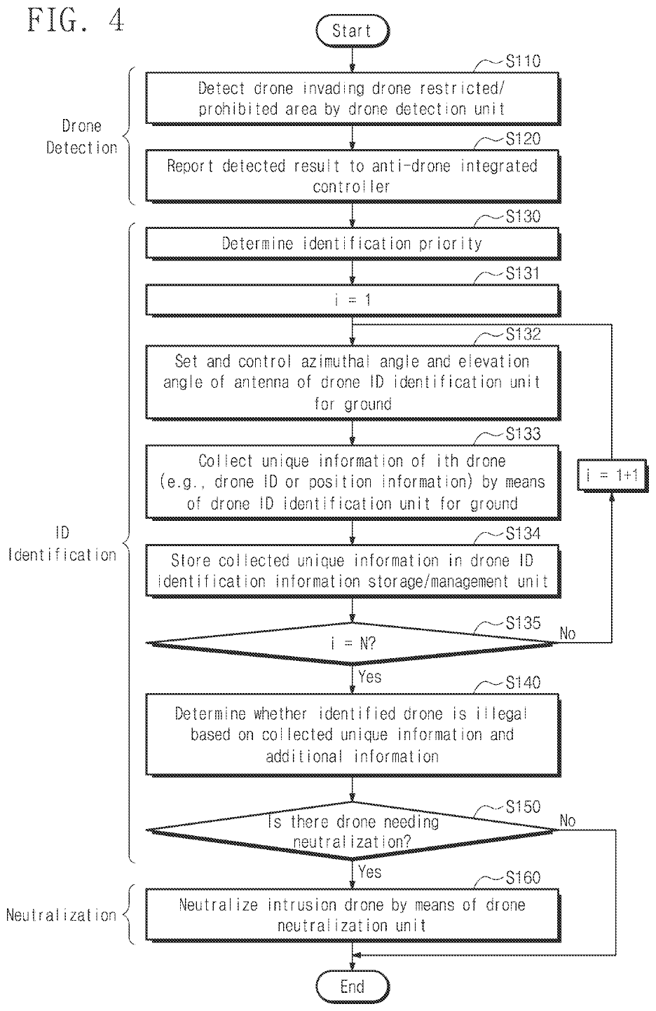

FIG. 4 is a flowchart illustrating an operation method of an anti-drone integrated management device according to an embodiment of the present disclosure. Referring to FIG. 4, an anti-drone integrated management device 200 according to an embodiment of the present disclosure may perform a drone dysfunction response process through three operations of drone detection, ID identification, and neutralization.

In operation S110, a drone detection unit 210 may detect an object invading a drone restricted/prohibited area 100. The drone detection unit 210 may search for the drone restricted/prohibited area 100 using at least one of a radar, an RF scanner, an EO/IR camera, and a general camera sensor.

When at least one drone is detected in the drone restricted/prohibited area 100, in operation S120, the drone detection unit 210 may report the detected result to an anti-drone integrated controller 250.

In operation S130, the anti-drone integrated controller 250 may determine identification priorities when there are two or more drones, the detection of which is reported. Priorities may be determined according to position information of the drone, which is reported from the drone detection unit 210, and anti-drone response rule previously determined according to an operation environment, an operation purpose, or the like of an institution which operates an anti-drone integrated management system. For example, a priority of a drone close in distance from a point where the anti-drone integrated management system is installed may be set high. Alternatively, a drone closer from major key facilities in the drone restricted/prohibited area may be determined to have a higher priority.

In operation S131, a drone having the highest priority or a drone where there is one detected drone may be selected.

In operation S132, the anti-drone integrated controller 250 may set an azimuthal angle and an elevation angle of an antenna 221 installed in a drone ID identification unit 220 for ground. In other words, the anti-drone integrated controller 250 may control an azimuthal angle and an elevation angle of the antenna 221 installed in the drone ID identification unit 220 for ground, using the position information of the drone reported from the drone detection unit 210 to efficiently receive drone unique information transmitted from the selected drone.

In operation S133, the drone ID identification unit 220 for ground may collect drone unique information (e.g., a drone ID, position information, or the like). In other words, the drone ID identification unit 220 for ground may request drone unique information from the selected ith drone. When the ith drone transmits a drone ID, position information, and the like in response to the request of the unique information, the drone ID identification unit 220 for ground may receive the information as information about the ith drone.

In operation S134, the drone ID identification unit 220 for ground may transmit the received unique information of the ith drone (e.g., a drone ID, position information, or the like) to a drone ID identification information storage/management unit 230 through the anti-drone integrated controller 250 or directly. The drone ID identification information storage/management unit 230 may store the unique information of the ith drone (e.g., the drone ID, the position information, or the like).

In operation S135, the drone ID identification unit 220 for ground may determine whether the currently selected ith drone corresponds to a drone of a last priority among the plurality of detected drones. As a result of the determination, an operation branch about whether to select a drone of a next priority or end drone selection may occur. When the currently selected ith drone is the last drone among the plurality of detected drones (Yes direction), the operation may move to operation S140. However, when there is a drone which is not selected among the plurality of detected drones other than the currently selected ith drone (No direction), the operation may move to operation S136.

In operation S136, a drone of a next priority (i+1) among the plurality of detected drones may be selected. When the drone of the next priority is detected, the operation may return to operation S132 to be fed back to an operation for controlling an azimuthal angle and an elevation angle for the selected drone.

In operation S140, the anti-drone integrated controller 250 may determine whether at least one detected drone illegally operates based on the drone unique information (e.g., the drone ID, the position information, or the like) stored in the drone ID identification information storage/management unit 230 and additional information. Herein, the additional information may include body registration information, owner information, flight approval information, or the like of the drone, which is obtained by interworking with a database of government agencies.

In operation S150, an anti-drone integrated controller 250 may determine whether there is a drone needing neutralization among the identified drones. When it is determined that the at least one detected drone illegally operates and when there is the drone needing the neutralization (Yes direction), the operation may move to operation S160 for neutralization of the drone. On the other hand, when there is no drone which is a neutralization target among the identified drones (No direction), after taking additional necessary measures, the neutralization operation for the detected drones may be ended.

In operation S160, the anti-drone integrated controller 250 may neutralize a neutralization target drone by means of a drone neutralization unit 240. The drone neutralization unit 240 may neutralize an illegal drone by means of jamming, destruction, capture, geofencing, or the like.

Recently, interest in an anti-drone integrated management technology for effectively responding to an illegal drone invading a drone restricted/prohibited area, such as an airport or a nuclear power plant, or a restricted area is growing. There is a need to essentially collect and use drone ID identification information to protect important facilities, respond to disaster, or quickly and flexibly respond to an illegal or threat drone in an event or the like. Because an existing anti-drone system relies only on a drone detection technology and a neutralization technology, there are difficulties in effectively responding to illegal activities, for example, follow-up measures such as identification of liability and insurance processing upon occurrence of an accident, and unilateral suspension of operation without considering the purpose of drone operation. As the anti-drone integrated management system and the operation method thereof are proposed in an embodiment of the present disclosure to overcome it, it is expected that it will be possible to build an advanced anti-drone integrated management system by supplementing disadvantages of the existing anti-drone response technology.

The above-mentioned description refers to embodiments for implementing the scope of the present disclosure. Embodiments in which a design is changed simply or which are easily changed may be included in the scope of the present disclosure as well as an embodiment described above. In addition, technologies that are easily changed and implemented by using the above-mentioned embodiments may be also included in the scope of the present disclosure.

What is claimed is:

1. An anti-drone integrated management device, comprising:
a drone detection unit configured to detect at least one drone invading a restricted area;
a drone ID identification unit configured to request drone unique information to the at least one detected drone and to receive the drone unique information from the at least one detected drone;
a drone ID identification information storage/management unit configured to store and update the drone unique information received by the drone ID identification unit;
an anti-drone integrated controller configured to determine whether to neutralize the at least one detected drone based on the drone unique information stored in the drone ID identification information storage/management unit; and
a drone neutralization unit configured to neutralize the at least one detected drone under control of the anti-drone integrated controller.

2. The anti-drone integrated management device of claim 1, wherein the drone unique information includes ID information assigned to the at least one detected drone or position information.

3. The anti-drone integrated management device of claim 2, wherein the drone ID identification unit includes at least one antenna, and
wherein the anti-drone integrated controller adjusts an azimuthal angle and an elevation angle of the at least one antenna based on the position information.

4. The anti-drone integrated management device of claim 2, wherein the drone ID identification unit includes at least one antenna, and
wherein the drone ID identification unit receives the position information and adjusts an azimuthal angle and an elevation angle of the at least one antenna without intervention of the anti-drone integrated controller.

5. The anti-drone integrated management device of claim 1, wherein the anti-drone integrated controller determines response priorities for a plurality of drones depending on a predetermined policy, when the plurality of drones are detected.

6. The anti-drone integrated management device of claim 5, wherein the response priorities are determined according to a distance from major key facilities in the restricted area among the plurality of drones or a distance from the anti-drone integrated management device.

7. The anti-drone integrated management device of claim 1, wherein the anti-drone integrated controller determines whether to neutralize the at least one detected drone by additionally using flight registration information, owner information, or flight approval information of the at least one detected drone other than the drone unique information.

8. The anti-drone integrated management device of claim 1, wherein a wired link or a wireless link for transmitting a command, control, or data in real time is configured between the drone ID identification unit and the drone ID identification information storage/management unit or between the anti-drone integrated controller and the drone ID identification unit, the drone ID identification information storage/management unit, the drone detection unit, or the drone neutralization unit.

9. The anti-drone integrated management device of claim 1, wherein the at least one drone includes an identification device for drone mounting for providing the drone unique information to the drone ID identification unit.

10. The anti-drone integrated management device of claim 1, wherein the drone detection unit, the drone ID identification unit, the drone ID identification information storage/management unit, the anti-drone integrated controller, and the drone neutralization unit are spaced apart from each other above a specific distance to be scattered and arranged.

11. An operation method of an anti-drone integrated management device for monitoring a restricted area, the operation method comprising:
detecting at least one drone invading the restricted area;
obtaining ID information and position information of the at least one detected drone;
determining whether to neutralize the at least one detected drone based on the ID information, the position information, and additional information; and
neutralizing the at least one detected drone depending on the determined result.

12. The operation method of claim 11, wherein the additional information includes body registration information, owner information, or flight approval information about the at least one detected drone.

13. The operation method of claim 11, further comprising:
determining response priorities for a plurality of drones, when the at least one detected drone is the plurality of drones.

14. The operation method of claim 11, wherein the anti-drone integrated management device includes a drone ID identification unit having an antenna for receiving the ID information and the position information provided from the at least one detected drone,
further comprising:
adjusting an azimuthal angle and an elevation angle of the antenna to receive the ID information and the position information.
